(19) United States
(12) Patent Application Publication
(10) Pub. No.: US 2016/0217416 A1
(43) Pub. Date: Jul. 28, 2016

(54) ANTHOLOGY AND ARCHIVING PLATFORM AND DISPLAY SYSTEM FOR COLLECTIBLES, METHODS AND USES THEREOF

(71) Applicant: Collectors Universe, Santa Ana, CA (US)

(72) Inventors: Bobbie Jo Searls, Austin, TX (US); David G. Hall, Coto de Caza, CA (US); John C. Nelson, Laguna Beach, CA (US)

(21) Appl. No.: 14/603,280

(22) Filed: Jan. 22, 2015

(51) Int. Cl. G06Q 10/08; H04L 29/08

(52) U.S. Cl. CPC G06Q 10/087; H04L 67/02

(57) ABSTRACT

An anthology and archiving platform and display system for collectibles is disclosed that includes: at least one imaged and archived, collectible, at least one piece of identifying, or valuation information associated with the at least one collectible, a digital platform system, wherein the system: associates the archived or imaged collectible with the piece of information associated with the collectible, actively identifies at least one piece of additional information associated with the collectible, produces a digital display album, wherein the album is uniquely designed for that collectible, wherein the image and the associated information are displayed. Corresponding methods of using the platform and display system are also disclosed.

### FIELD

Embodiments described herein relate to building and displaying anthologies of collectibles using an anthology and archiving platform and display system.

### BACKGROUND

Collectible items, such as coins, stamps, sports cards and cars, were sold and acquired through shops, private sales and trade shows until the widespread acceptance and use of the Internet. Now, most collectors purchase collectibles through a variety of services, including internet stores, auction websites, trade shows, traditional brick and mortar stores and/or other collectors. Collectors are now imaging their collectibles for both insurance purposes and display to other collectors. Conventional imaging merely includes taking a photo of the collectible or pulling a stock photo of the collectible and either storing it on a computer, in the Cloud, or including it as part of a set registry that is found online through companies, such as Collectors Universe.

U.S. Pat. No. 6,366,899 issued to Kernz and titled “Apparatus and Method for Accessing a Coin Image Compilation” discloses the early use of an online database for coin graders and collectors to upload and display their inventory. Specifically, Kernz disclosed: “A method for providing a database of images of graded objects comprising the steps of: a. grading an object based upon a predetermined grading scale and generating a grade indicator for the object; b. associating the grade indicator with the object in a tamperproof manner; c. assigning a unique identifying indicia to the object and associating the unique identifying indicia with the object in a tamperproof manner; d. generating a compilation of associated images of the object including a gross image, at least one magnified image and at least one image showing the object with the associated grade indicator, digitizing the images for viewing and assigning the unique identifying indicia to the compilation; e. storing the compilation associated with the unique identifying indicia in a database; and f. repeating said steps a. through e. for a plurality of objects to generate an associated compilation of images for each object and to store the compilations in the database whereby each of the compilations can be retrieved from the database by selecting the assigned associated unique identifying indicia and the images in the retrieved compilation can be viewed.” The stated goal of this subject matter was to make it easier for collectors to list their inventory and for potential purchasers to be able to access a particular inventory online. U.S. Pat. No. 6,643,666, also issued to Kernz, continued this line of subject matter by creating a marketplace computer for electronically trading graded objects.

U.S. Pat. No. 6,640,323 issued to Kernz is a continuation of the above-referenced patents and discloses apparatus and methods for selectively displaying a coin image compilation, along with US Patent Publication 2004/0039663, which is now abandoned. The latter publication discloses an “improved market exchange environment” or a “virtual active marketplace” where buyers and sellers can use interconnected computers to trade objects to be collected. These four Kernz patent references teach the online listing of collectibles, along with the buying and selling of those collectibles, but fails to improve the process past that point.

To this end, it would be desirable to develop, produce and create a system that: a) allows collectors to catalog and archive their own collectibles on one platform, regardless of whether they are already imaged online, b) allows collectors to compare their individual collectibles or sets to other publicly-listed collections, c) provides an easy and visual compilation of their own collectibles that can be used for insurance or valuation purposes, and/or d) allows collectors to produce their own digital sets of collectibles.

### SUMMARY

An anthology and archiving platform and display system for collectibles is disclosed that includes: at least one imaged and archived collectible, at least one piece of identifying or valuation information associated with the at least one collectible, a digital platform system, wherein the system: associates the archived or imaged collectible with the piece of information associated with the collectible, actively identifies at least one piece of additional information associated with the collectible, produces a digital display album, wherein the album is uniquely designed for that collectible, wherein the image and the associated information are displayed. Corresponding methods of using the platform and display system are also disclosed.

### BRIEF DESCRIPTION OF THE FIGURES

FIGS. 1A-1D illustrate an exemplary anthology and archiving platform and display system for collectibles, where FIG. 1A illustrates an exemplary display system for a set of collectibles; FIG. 1B illustrates an exemplary display and edit system for a set of collectibles; FIG. 1C illustrates an exemplary display system for a set of collectibles as accessed by a user; and FIG. 1D illustrates an exemplary association feature of the display system for collectibles.

FIGS. 2A-2B illustrate an exemplary user interface for a collectibles database, in which FIGS. 2A and 2B represent top and bottom portions of a display respectively.

FIG. 3 illustrates an exemplary online and mobile interface for obtaining missing collectibles from their sets.

### DETAILED DESCRIPTION

A system has been developed and is described herein that: a) allows collectors to catalog and archive their own collectibles on one platform, regardless of whether they are already imaged online, b) allows collectors to compare their individual collectibles or sets to other publicly-listed collections, c) provides an easy and visual compilation of their own collectibles that can be used for insurance or valuation purposes, and/or d) allows collectors to produce their own digital sets of collectibles. Contemplated systems are a true advancement over current, flawed and incomplete methods for archiving and displaying collectibles. In addition, this platform transforms information and images that may be spread out on several electronic folders and physical locations, archives them, compiles them and transforms them into something more—a digital display album—that can be used for both recreational purposes and insurance or valuation purposes.

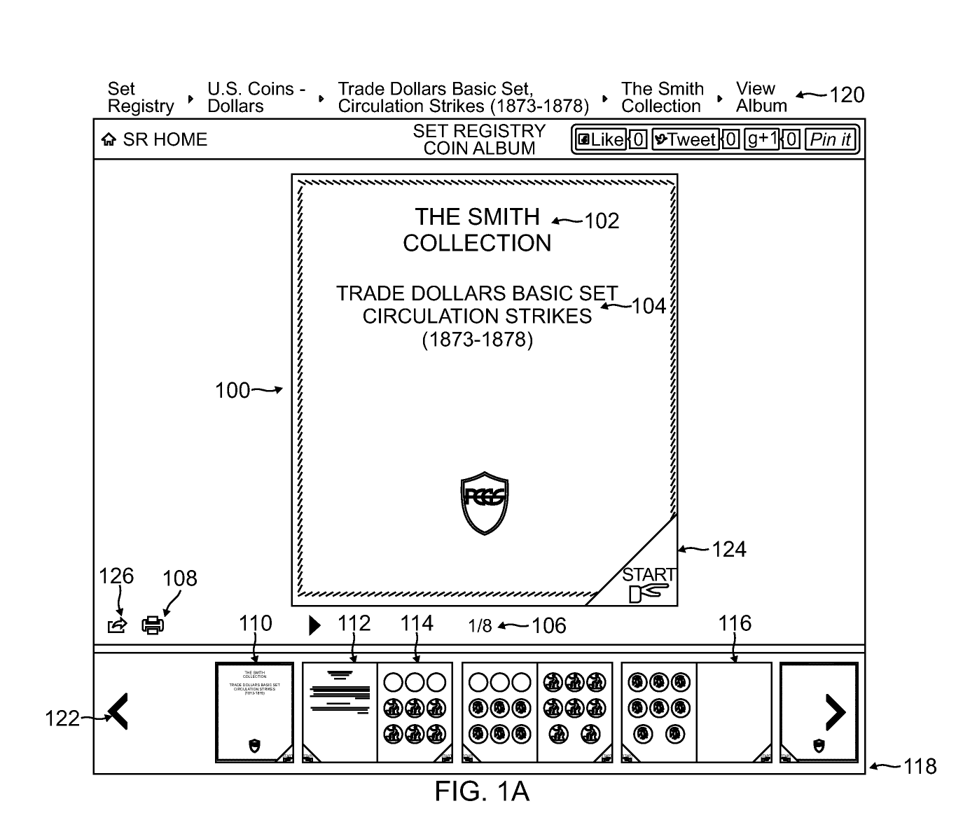

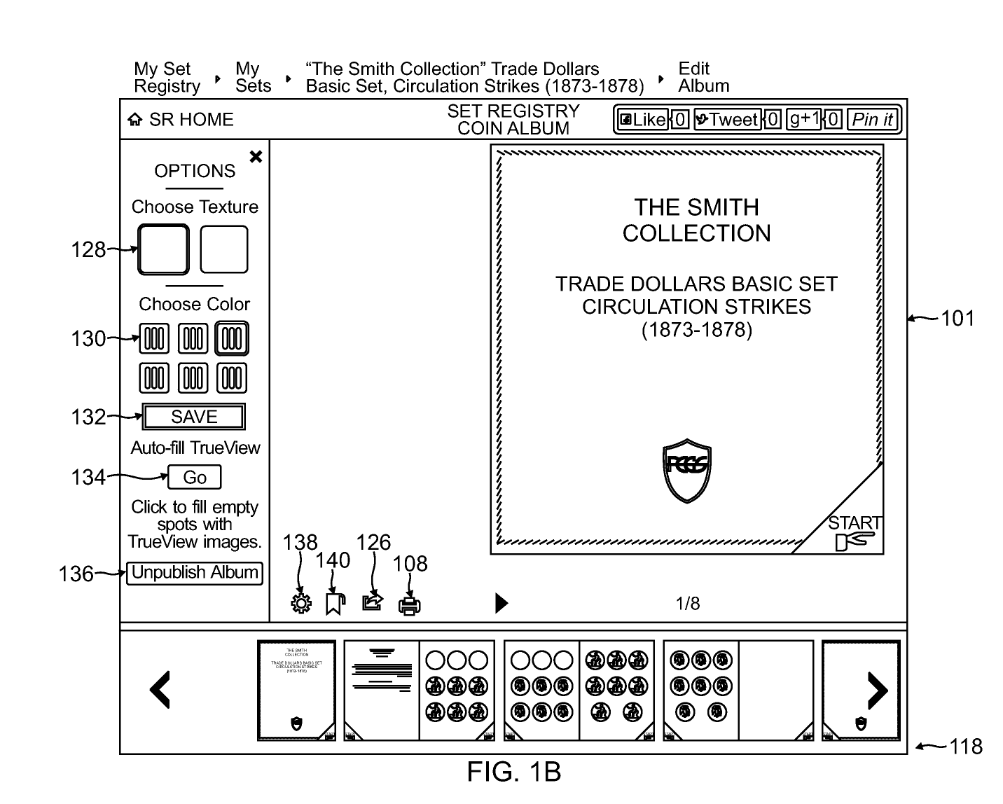

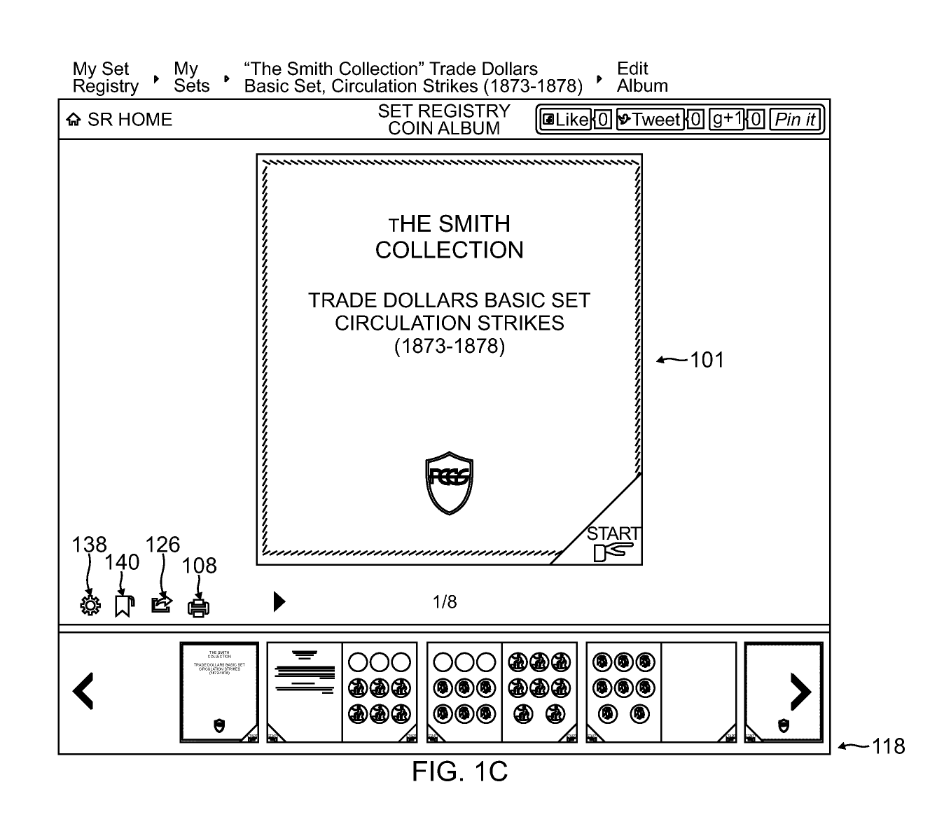

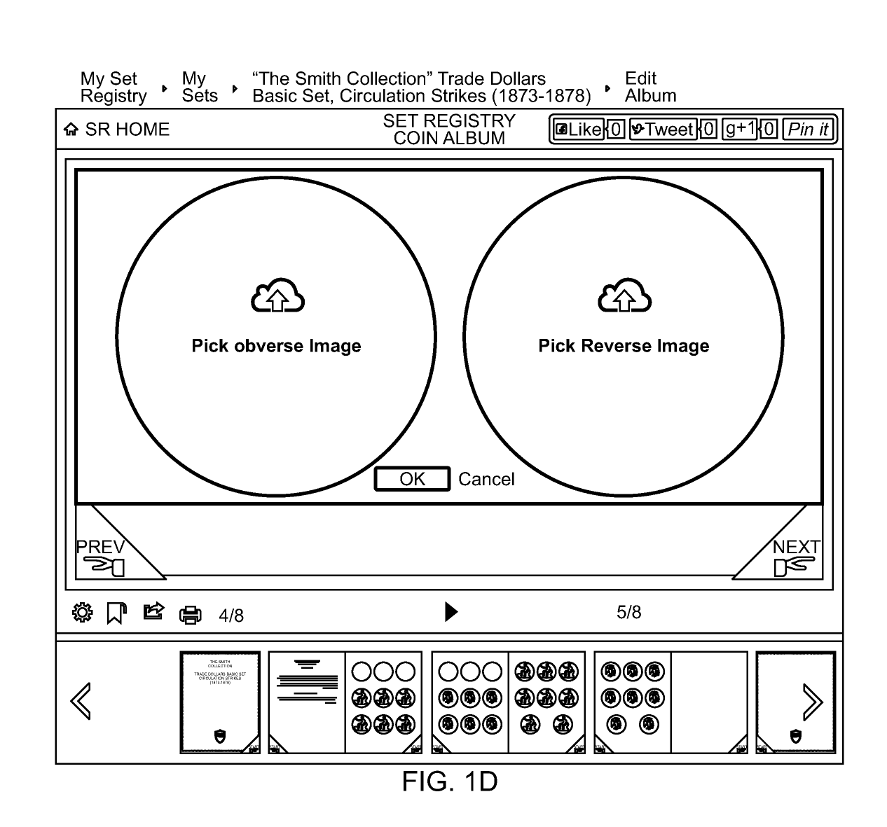

Specifically and as shown in FIG. 1, an anthology and archiving platform and display system for collectibles is disclosed that includes: at least one imaged and archived collectible, at least one piece of identifying or valuation information associated with the at least one collectible, a digital platform system, wherein the system: associates the archived or imaged collectible with the piece of information associated with the collectible, actively identifies at least one piece of additional information associated with the collectible, produces a digital display album, wherein the album is uniquely designed for that collectible, wherein the image and the associated information are displayed. Corresponding methods of using the platform and display system are also disclosed.

Software applications that can be saved on a smartphone, tablet, computer or laptop and that can access the systems and methods disclosed herein are also contemplated.

Contemplated collectibles are tangible items that are unique and have value to collectors, including coins, cards, paper currency, art, cars, autographed items, vinyl records, and any number of other items. Generally, a collector purchases their items and stores them in various places, including at home, in vaults, in a safe or another secure, possibly climate-controlled location. Collectors may have imaged the items on his or her own, may rely on stock images provided by the collector or a combination of both. In any event, it is likely that any collected images are stored in as many different places as the collectibles themselves, including a computer hard drive, the Cloud, a phone SIM card, a physical photo on paper or a combination thereof

In a contemplated embodiment, a collector starts with at least one archived or imaged collectible. Data about the contemplated archived or imaged collectibles are sufficiently stored in one place, such as in a database or another storage platform. This database is the electronic collection and representation of identifying information related to a physical collection of collectibles.

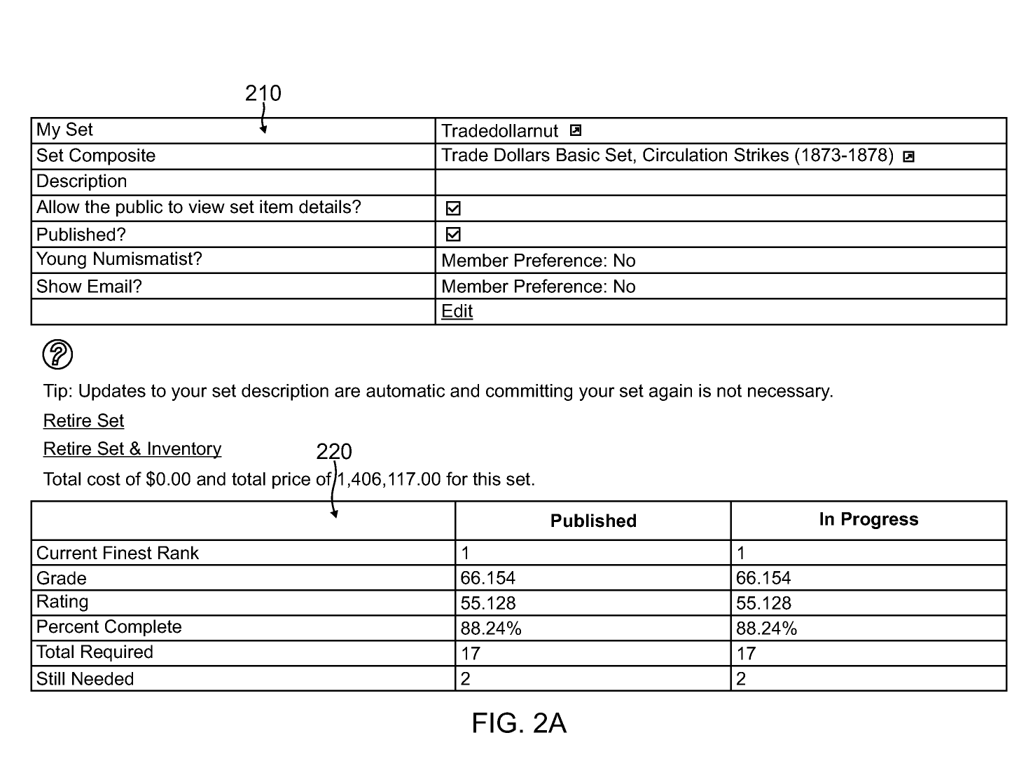

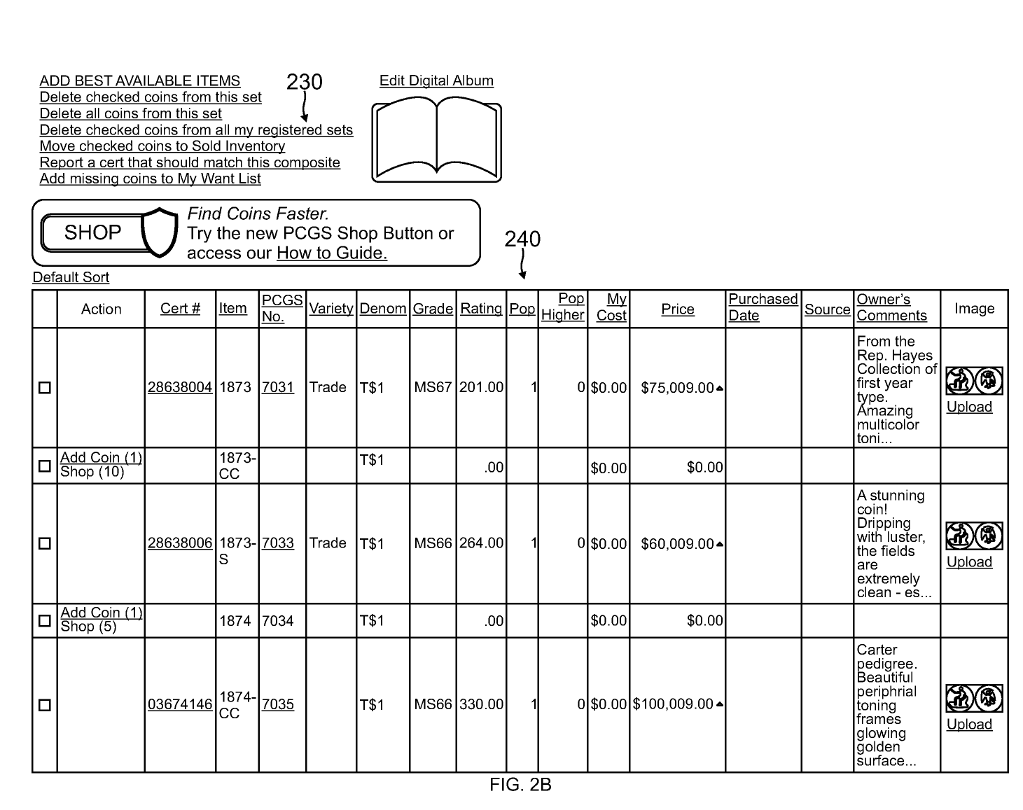

For example, a collector may have a set of collectible coins at home in a vault. The identifying information, including type, value, condition and other suitable information, along with a photo, is uploaded to or entered into the collectibles database, which represents what the collector currently has in his or her collection. This information can also be used to compare with other collectors' sets through a set registry, such as the PCGS Set Registry, wherein collectors can register their coin sets, compare their sets with other collectors and compete with other collectors for who has the better coin set. FIG. 2A shows information 210, 220 for a user's Collectibles Database at the top of the page, including the rank, the degree of completion, etc. As the user toggles or scrolls down the page or navigates to a separate page as shown in FIG. 2B, the user is provided links 230 to “Add Best Available Items”, which will provide information on how to globally update the user's set with any available items in the Global Collectibles Database, Delete or Move Coins within the set, Sell Coins out of the First Subject Collectibles Database or add Missing Coins to the Want List (“Coins I Need”). The user is then presented with all of the available coins 240 from the Global Collectibles Database that the user may want to view to add to and/or improve his or her set.

A user's contemplated database is updated on a regular basis—either at particular and specific time intervals or randomly over a given period of time. If the user adds a new collectible to the set, the archival information, image information or both will be added to the database and is eligible to be added to a new or existing digital album.

As contemplated, each archived or imaged collectible will have at least one piece of identifying or valuation information associated with it. For example, at least one piece of identifying or valuation information may include the name of the collectible, circulation year, autograph identifier, series number, production year, catalog value, purchase price, previous owner, quality grade, or any other piece of suitable collectible information, and any combination thereof. This information may be information that is inputted by the owner, provided by a resource, such as a catalog or vendor, or a combination of both. Contemplated collectibles catalogs are those catalogs that are prepared, and in many instances proprietary, to a company who specializes in collectibles. One example of a contemplated catalog is PCGS Numbering System, which contains information about United States and World coins and can be found at http://www.pcgs.com/pcgsnolookup/.

A digital platform system is contemplated, wherein the system associates an archived or imaged collectible with the at least one piece of information associated with the collectible. The platform then actively identifies at least one piece of additional information associated with the collectible that may or may not be initially or originally available when the collectible is first archived or imaged. Then, the platform produces a digital album that is uniquely designed for that collectible. The image and the information is displayed in a standard format. The user initiates the digital platform system by finding and clicking on a link or icon that is found on the user's online and/or mobile dashboard.

In an exemplary embodiment, a user may add a collectible to their inventory. The user may provide one or more pieces of identifying or valuation information as described herein. The platform may then retrieve and associate or store one or more pieces of identifying or valuation information. For example, the platform may search public files, local files, and/or networked files such as from the internet, other modules or databases of the platform, other modules or databases of public or private networks associated with or communicating with the digital platform system (for example, a resource), etc. The platform may then associate or store the retrieved information in a database of the entered collectible. In an exemplary embodiment of a coin collection, if a certification number is entered then the system may retrieve the associated grade, pedigree, denomination, variety, etc. from a system of the resource that gave the certification. The user may then indicate whether the collectible had been professionally imaged, imaged through a service, or personally imaged. The platform may communicate or be integrated with the platform for imaging such that the system may automatically retrieve the images on file or may permit the user to upload the images from a storage medium. The user may be permitted to size, orient, etc. the images as described herein. The retrieved and entered information, images, etc. may be associated to or stored in one or more databases. From the retrieved or entered information, the system may automatically create a digital presentation layout for the desired collectibles with spaces allotted for each item of a set. For example, once the set description is known and/or some specific identifier of individual collectibles, then the system may supply the appropriate number of spaces and/or the appropriate sized locations for receiving collectibles corresponding to the set/collectible descriptors.

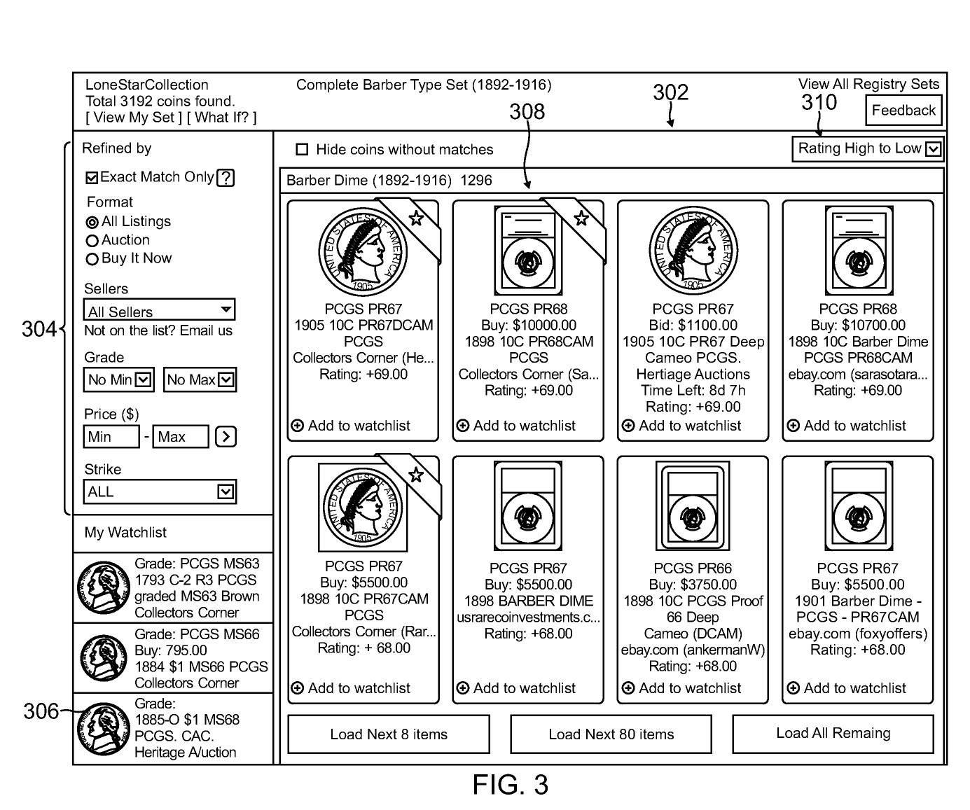

It is contemplated that all of the contemplated databases and modules may interface with one or more other features such that the user may, for example, purchase missing collectibles from their sets. For example, a shop feature 300, as shown in FIG. 3, may show a number of contemplated features, including search filters 304, watched or tagged collectibles 306, search results 308, priority or relevance sorter/filter 310, etc. The shop feature may be accessible to a user through a link, icon, or portal within the embodiments described herein, such that a user can navigate between modules including, for example, the display, inventory, and shop.

A contemplated interface may also provide links, excerpts, or summaries, or compilations of user's current collections, albums, sets, purchases, searches, etc., so that they are easily accessible from one place. Accordingly, it is contemplated that all of the contemplated databases, modules, and interfaces can be easily and simply represented on or accessible from a user's Online and Mobile Dashboard. The Dashboard may show a number of contemplated features, including “Produce Digital Album,” which accesses the digital platform and starts the process of building the album for the user. A contemplated dashboard may also provide links to the user's current collections, so that they are easily accessible from one place. A contemplated dashboard may also provide alert notices, an interface to the sales module, a running ticker of online news and alerts related to the user's collections and preferences, and a number of other pieces of information. It is also contemplated that the online and mobile dashboard can be set up according to each user's preferences and what he or she wants to see when it is accessed. It is also contemplated that various aspects of the Online and Mobile Dashboard can be accessed immediately as the user is using the various features of the overage marketplace. The Dashboard may also be set up and communicated in app form on a smartphone, tablet or laptop. In these embodiments, the user can set up preferences and layout as well, and that layout may be different than the one found on the user's internet profile or layout.

Each of the modules or interfaces may also include links to access or navigate to one or more other modules or interfaces as described herein. For example, a user may start with creating a visual compilation of their collectibles which can then be used to build or produce their own digital sets of collectibles. The user may then navigate from either the visual compilation to their digital set inventories to the sales module to view, watch, or purchase missing collectibles for their sets. Alternatively, the user may start with building a digital set of collectible in a registry or inventory and then create the visual compilation from their inventoried sets. Alternatively, the user may start by purchasing inventories, which can be entered or transferred to or used to create an inventory or visual compilation. The dashboard may be used similar to a home page to display a summary of one or more features from one or more of the modules or interfaces described herein.

As described herein, contemplated embodiments can be stored on, executed from or accessed from a central server, network server, a central Cloud or another multi-user accessible and/or two-way system. In some embodiments, a contemplated handheld device, portable device or combination thereof may comprise a software “app” that is designed to access the Dashboard and any other piece of the contemplated system in order to present the user with a completely mobile, completely accessible system and Dashboard.

As part of these systems, a display device may be included that comprises a digital display, an interactive display with keyboard (actual, digital or voice recognition-enabled), a combination digital and paper artwork display or a combination thereof. Contemplated collectibles systems are designed to and have components that allow them to communicate with the handheld device, portable device or combination thereof.

Contemplated systems may also comprise a user-utilized handheld device, portable device or combination thereof. Contemplated devices may include a smart phone, hand held device, laptop computer or another suitable device with a network connection, data transfer connection, network data connection, cellular data network and/or connection, Wi-Fi connection, or another suitable device/link combination or connection that allows the user to communicate with contemplated collectibles systems, as disclosed herein.

Contemplated systems embodiments and related applications or apps are saved on, executed on, stored on or located on a portable media storage device, a hand held device, a tablet computer, a laptop computer, a desk top computer, a network server, an internet server, the cloud or a combination thereof

FIGS. 1A-1D illustrate an exemplary anthology and archiving platform and display system for collectibles. In an exemplary embodiment, the archiving platform and display system permits a user to add collectibles to a database. The system then permits a user to select collectibles for display and create a digital display for the selected collectibles. The user may edit and customize the display, such as by providing descriptions, titles, color schemes, font characteristics, images, textures, etc. The system may provide automatic features, such as display location and formatting (such as size, orientation, and/or location) based on the type of collectible or one or more attributes of the collectible or the collection. For example, if a card collection is being created, the system may automatically provide rectangular slots in the appropriate size for the desired image of the collectible. Similarly, if coins are the desired collectible, the holes commiserate with the desired image of the coin. Description attributes, such as value, denomination, date, name, etc. may also be provided based on the collectible type or category.

FIG. 1A illustrates an exemplary display system for a set of collectibles. The illustrated display is of a public view published by a user and accessible to a given public. The user may restrict access to the albums or permit unrestricted public viewing. Accordingly, the platform and system is configured to provide a user interface to an audience other than the user to display the collectibles selected and configured by the user. As shown, the collection for public display 100 includes a title 102, description 104, and a number of pages 118 to display the user selected collectibles. The user interface includes one or more features for navigating the display, such as thumbnail images of the pages 118 or scrolling features 122, 124. The system may also display information about an album, or functions that may be performed on the display 108.

In the illustrated exemplary embodiment, the anthology and archiving platform and display system comprises a user interface to display an album of selected collectibles to the public. The album may include one or more virtual pages comprising a digital image of a page. The pages, for example, may include a front cover 110, title or description page 112, one or more pages of collectible images 114, a back cover 116, and any combination thereof. The album may be navigated by selecting a desired page 118 from a thumbnail menu, or traversing pages by selecting a page changing icon 124, or through one or more other scrolling 122 or selection interfaces (icon selection, gesture recognition, automatic timing, etc.). A user may also select to perform features on the album, such as print, play, or share. Other navigation options 120 may be made available to the public user to navigate within the larger platform for which the album in a part.

FIG. 1C illustrates an exemplary display system for a set of collectibles as accessed by a user. The user may select a set of collectibles for display and insert the collectibles into the provided display system.

For certain collectibles, the user may already have images taken and saved, such as through a collectors service. For example, Professional Coin Grading Service offers Trueview images that are high resolution images of the obverse and reverse sides of a coin collectible. Embodiments described herein may include an integrated platform that permits a user to save personal collections including images taken and configure those collections into a displayed format. The platform may interface with one or more levels such that a user may keep a personal collection, inventory, images, etc. and one or more displayed collections. The one or more levels may communicate such that information added by a user on one level may be automatically added or suggested to the user to add or include on another level.

FIG. 1B illustrates an exemplary display and edit system for a set of collectibles. The illustrated display is of a user interface available to a user to edit the available display options and inserted collectible images. For example, the user may be given one or more editable display options, such as color 130 and textures 128. Other editable features may include images, layout, themes, styles, borders, page sizes, etc. The user may access the editable features by selecting an edit or settings icon 138. An exemplary display 101 of the selected features may be provided to the user. The user may save their progress in creating the display at any time by selecting a display icon 132, typing in a combination of inputs such as through a keyboard, or providing some other input into the system. If the user attempts to leave the interface, the user may be prompted to save their edits.

Once the user is finished designing their display, they may select to permit viewing by others. For example, the user may select a publish or un-publish icon 136 that indicates whether the display selection can be accessible by other users or the public.

Each page or album may have one or more functions available. For example, a page may be Bookmarked, Shared, Printed, Thumbnail, Zoomed In, Zoomed Out, Played, Manually Navigated (First Page, Previous, Next, Last Page).

If “Bookmarks” is clicked the user will be able to bookmark certain pages within the album. This will be especially useful on larger sets. For example, a bookmark icon 140 may be provided to a user to select individual pages. The pages may then be presented to the user for selection. The user may bookmark pages of particular interest or to indicate incomplete actions, etc.

In an exemplary embodiment, a page or an album may be shared. For example, if “Share” is clicked, the user will have the opportunity to email a link to the album to a friend and/or post on a number of websites. The “share” may be indicated by for example, an icon 126.

In an exemplary embodiment, the digital album may be printable. The user can print the entire album or select specific pages. Accordingly, the user may be given an icon 108 to select printing of a page or album.

In an exemplary embodiment, a panel of thumbnail images is provided of one or more pages of the album. The thumbnail view will allow users to select a specific page to view.

In an exemplary embodiment, a user may be provided one or more options for selecting or enlarging images for viewing. For example, in the public mode, when rolling the cursor over an image, an enlarged magnified image may be shown. In the Edit mode, the user may click on an image to produce a large image.

In an exemplary embodiment, the user may select to play an album. If the user selects “Play” the album will begin on page 1 and automatically flip pages through to the last page at a selected interval. The “Play” link becomes “Pause” until the user clicks “Pause”.

In an exemplary embodiment, the user may be permitted to navigate through the album in one or more ways. For example, a user may be provided icons, such as Start, Previous, and Next to let the user move through the album at his own pace.

An exemplary method of creating an album according to embodiments described herein is provided. The exemplary embodiment is described in terms of coin collectibles and may include the Trueview imaging. The specific features, order, available functions and selections are exemplary only and not intended to be limiting.

To begin, the user will view one of his sets in My Set Registry on the My Collection page or in the Collectors Showcase in one of his self-created sets, such as those illustrated in FIGS. 2A-3. There he will find a link to Create Digital Album just above the list of coins in his set. For example, provided links 330 of FIG. 2B or information 310, 320 may include a link to My Album or Create Digital Album.

The album may be customized to each set in the Registry based on the coin number to determine date, denomination, and in the case of type sets and showcase sets, the size of the hole relative to other coins in the set. The certification number will determine the grade. So if the set has 17 coins, the album will have 17 holes. Each hole may be labeled with the date, denomination (or other information relevant to the specific collectible), and grade. The order of the coins will be determined by the placement of the coin in the set. So if the coin is in the first slot in the set, it will appear in the first hole in the album.

Once the user clicks Create Digital Album he will be given the option to select a color palette for his album, such as, for example, illustrated in FIG. 1B. As shown, there are six color palettes of browns, reds, blacks, blues, greens and purples. There are also at least two cover “textures” that can be changed or modified. Any combination of color selections, textures, designs, fonts, images, or other customizable feature may also be selected for a given album.

As an example, an album image will appear in the default color for the set the user is building. The user may build a copper coin album. If the user picks a different color, the album cover color will change so he can see what it looks like.

After the user selects the color for his pages, he will begin adding coins to his album. He will have the option during album creation to change the color palette.

In an exemplary embodiment, after the user clicks Create Digital Album he will be given two choices. He can allow the program to auto-fill all the Trueview images or he can add the coins one at a time. For example, as seen in FIG. 1B, the user may be provided an icon to select autofill with Trueview images. Otherwise, the user may select a page and an empty or filled location to bring up an interface to add or edit an associated image, such as that illustrated in FIG. 1D. Trueview images may be, for example, a high resolution image created by a resource or vendor and digitally stored by the resource or vendor. The system may be integrated with or communicate with the resource or vendor system to retrieve the high quality professional image of the entered coin and automatically save the image or associate the image to the collectible database and/or digital album.

To add coins one at a time each hole in the album will display with a place for the obverse and reverse. The user will add his image by clicking in each hole. He will need to increase the size and position of the coin in the hole. The system may automatically provide holes of appropriate size depending on the denominations associated with the displayed set.

In addition, if the user has several images attached to his coin, he may want to remove images until he places the one he wants to use.

If a user has any Trueview images in his set and he wants to add all of those images once in his album he can select an auto-fill function. He will click the link for Create Digital Album. From the toolbar, the user will click “auto fill Trueview”.

If a user does not have Trueview imaging but has his own images, he will need to retrieve the image and position the image to fit the hole. He will follow the same steps as above, and he will position and increase or decrease his coin to fit the hole with the tools provided.

For example, as shown in FIG. 1D, the user may fill the obverse image and reverse image locations by selecting the desired hole, which will prompt the user to navigate to a saved image location. Once the user selects the desired image file, the image is uploaded to the database and displayed in the album. The user may also be provided one or more tool selections for cropping, sizing, rotating, and orienting the image. The original and/or modified image may then be saved to the database and linked to the display system along with the user's display selections.

When both obverse and reverse images have been placed, the user will click to the next hole. If he is missing the obverse or reverse image, he can still move to the next hole.

Finally, the user will have the opportunity to add text to the inside cover of his album. If the user has placed text in the set description box in his set in the Registry, that text will default to the inside cover page. The user will then have the opportunity to edit or delete the text.

Once the user has filled the holes with all the images he has available and saved his comments, he is ready to publish his album. He will select “Publish” from the tool bar. On his set page, the links will have changed from Create Digital Album to links for Edit Album. If he clicks Edit Album it will bring him back to the edit mode where he can scroll through his coins, remove and add images, and make adjustments to the text.

Once the user clicks Publish Album it will be placed in the Public Registry. Any edits that are made will display immediately in the album. If the user edits his album, the published album may automatically be updated consistent with the edits in approximately real time, the update may occur periodically such that the published album is updated periodically based on edits entered before a certain period, or the user may be prompted to republish the album when all the desired edits are complete.

On the public Registry, a book icon will display to indicate the presence of an album. Note that even if the user has his set closed from public viewing, if he publishes his album for public viewing, an icon will appear by his set name. There may be some who do not want their set open in the Registry because it may show Trueview images with certification numbers or coin numbers, but he may want to share his collection in the album format.

FIG. 1C illustrates an exemplary album in an edit mode. When a user clicks on Edit Album in My Set Registry or a visitor clicks on the book album icon, the opening screen will display the cover of the album. The title of the album will match the set composite the user is working from. If he is working from a Collectors Showcase set, the category name will display, i.e. My 10 Best Coins, Box of 20, etc.

The album may have a visual page turning feature. Because in real life these albums have stiff pages, it will be a hard flip effect. A left click on the page turners will flip the pages.

The album will have one hole for each item in the set. The person viewing the album can scroll over the coin to see an enlarged image. Therefore, for sets that are unfinished, empty holes may designate the locations of missing coins of the set. Alternatively, the album will have one hole for each item collected in the set, such that all holes include an image of an associated collectible in that set.

Thus, specific embodiments and systems for building and displaying anthologies of collectibles using an anthology and archiving platform and display system have been disclosed. It should be apparent, however, to those skilled in the art that many more modifications besides those already described are possible without departing from the inventive concepts herein. For example, different modules, features, and/or interfaces are disclosed. These modules, features, and/or interfaces may be integrated, separated, sub-divided, duplicated, removed, or recombined in any manner consistent with the specification without deviating from the inventive subject matter. The inventive subject matter, therefore, is not to be restricted. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. (canceled)

2. (canceled)

3. A system for building and displaying anthologies of collectible items, the system comprising:
a first non-transitory storage medium comprising:
a plurality of high resolution images associated with each of a plurality of collectible items, and
at least one piece of additional information associated with each of the plurality of collectible items, wherein the at least one piece of additional information comprises name of the collectible, circulation year, autograph identifier, series number, production year, catalog value, purchase price, previous owner, quality grade, or a combination thereof; and
a second non-transitory storage medium comprising:
a plurality of collectible item sets, each set comprising a plurality of collectible items and an image for each item of the plurality of collectible items,
at least one piece of identifying information associated with each collectible item of the plurality of collectible item sets,
at least one piece of additional information associated with each collectible item of the plurality of collectible item sets,
wherein the collectible items in each set each has at least one piece of information in common with other collectible items in the set, and
wherein the second non-transitory storage medium is different form the first non-transitory storage medium; and
a third non-transitory storage medium encoded with instructions for:
receiving from a user an image for a collectible item or at least one piece of identifying information associated with the collectible item;
storing the image or at least one piece of identifying information in the second non-transitory storage medium;
searching, retrieving, and storing in the second non-transitory storage medium the at least one piece of additional information from the first non-transitory storage medium for the collectible item associated with the collectible item received from the user;
permitting the user to save the high resolution image from the first non-transitory storage medium to the second non-transitory storage medium for the collectible item received from the user;
determining which set of the plurality of collectible item sets the collectible item received from the user is associated;
receiving input from the user to define an album theme;
digitally displaying the collectible item sets in the form of an album based on the defined album theme, the album comprising a front cover, a title page, collectible item pages and a back cover, wherein an image for each available collectible item in the set is displayed such that the each available collectible item in the set either has an actual image associated with the collectible item in the set or an image of a hole corresponding to the shape of the collectible item in the set designating a location of a missing collectible item in the set, wherein the actual image is either the image received from the user or the high resolution image received from the first non-transitory storage medium and the actual image is automatically sized such that each displayed collectible item in the collectible item set has an approximately correct relative size to each of the other collectible items in the collectible item set;
navigating the album;
digitally displaying an indication of the degree of completion for each set;
permitting the user to compare the collectible item set of the user with another collectible item set of another user and assign a relative rank of the collectible item set of the user; and
digitally displaying the relative rank for the collectible item set of the user.

4. A method for building and displaying anthologies of collectible items, the method comprising:
receiving from a first computer-readable medium at least one image for a collectible item and at least one piece of information associated with the at least one image;
storing the at least one image in a second non-transitory storage medium, the second non-transitory storage medium comprising a plurality of collectible item sets, each set comprising a plurality of collectible items and images for each collectible item, and at least one piece of information associated with each image of each collectible item;
searching for and retrieving at least one piece of additional information for the collectible items in the collectible item set;
associating the at least one piece of additional information with the collectible item of the collectible item set;
digitally displaying the collectible item sets in the form of an album, the album comprising a front cover, a title page, collectible item pages and a back cover.

5. The method of claim 4, further comprising searching for and retrieving at least one piece of additional information based on the at least one piece of information received from the user.

6. The method of claim 4, comprising searching one or more public files, local files, networked files or files available on the internet for the at least one piece of additional information.

7. The method of claim 4, wherein the at least one piece of additional information comprises name of the collectible item, circulation year, autograph identifier, series number, production year, catalog value, purchase price, previous owners, quality grade or a combination thereof.

8. The method of claim 4, further comprising retrieving high quality images of the collectible item of the collectible item set from a resource or vendor and associating the high quality images with the collectible item of the collectible item set.

9. The method of claim 4, further comprising digitally displaying an indication of the degree of completion for each set.

10. The method of claim 4, further comprising comparing at least two sets based on at least one piece of information and assigning a relative rank to each set.

11. A system for building and displaying anthologies of collectible items, the system comprising:
a non-transitory storage medium encoded with instructions for:
receiving from a user, a plurality of images for collectible items and at least one piece of information for each collectible items;
storing images received from the user in a non-transitory storage medium;
searching for at least one piece of additional information in public files, local files, networked files or files available on the internet, based on the at least one piece of information received from the user;
retrieving at least one piece of additional information for a collectible item in a set of collectible items;
associating at least one piece of additional information with the collectible item provided by the user; and
creating a publically accessible and searchable digital display of the collectible item set in the form of an album.

12. The system of claim 11, wherein the album comprises a front cover, a title page, collectible item pages and a back cover.

13. The system of claim 11, further comprising instructions for navigating the album.

14. The system of claim 11, further comprising instructions for communicating with a resource or vendor to retrieve high quality images of a collectible item, and automatically associating the high quality images with the album.

15. The system of claim 11, further comprising instructions for digitally displaying an indication of the degree of completion for each set.

16. The system of claim 11, further comprising instructions for comparing at least two sets based on at least one piece of information and assigning a relative rank to each set.

17. The system of claim 16, further comprising instructions for digitally displaying the relative rank for each set.

18. The system of claim 11, wherein the at least one piece of additional information comprises name of the collectible item, circulation year, autograph identifier, series number, production year, catalog value, purchase price, previous owners, quality grade or a combination thereof.

19. The system of claim 11, wherein digital displaying the album comprises automatically sizing the image received from the user to fill a hole in the album.
